(19) United States
(12) Patent Application Publication
(10) Pub. No.: US 2024/0351341 A1
(43) Pub. Date: Oct. 24, 2024

(54) METHOD FOR CONTROLLING LIQUID DISCHARGE DEVICE AND LIQUID DISCHARGE DEVICE

(71) Applicant: SEIKO EPSON CORPORATION, Tokyo (JP)

(72) Inventors: Hirokazu FUJII, SHIOJIRI-SHI (JP); Satoru KOBAYASHI, SHIOJIRI-SHI (JP)

(21) Appl. No.: 18/635,237

(22) Filed: Apr. 15, 2024

(51) Int. Cl. B41J 2/175

(52) U.S. Cl. CPC B41J 2/17566; B41J 2/1752; B41J 2/17526; B41J 2/17546; B41J 2002/17569

(57) ABSTRACT

A method for controlling a liquid discharge device includes, using, for discharge, when a remaining amount in one liquid storage portion used for discharge among three or more liquid storage portions mounted on a mounting portion on which three or more liquid storage portions of the same type can be mounted falls below a threshold value, liquid stored in a liquid storage portion having a minimum remaining amount among the liquid storage portions having a remaining amount equal to or greater than the threshold value.

The present application is based on, and claims priority from JP Application Serial Number 2023-067957, filed Apr. 18, 2023, the disclosure of which is hereby incorporated by reference herein in its entirety.

### BACKGROUND

### 1. Technical Field

The present disclosure relates to a method for controlling a liquid discharge device such as a printer, and the liquid discharge device.

### 2. Related Art

For example, as disclosed in JP-A-2015-116725, there is a recording device that is an example of a liquid discharge device that discharges ink, which is an example of liquid stored in a large-capacity ink container, which is an example of a liquid storage portion, from a nozzle, and performs recording. When a remaining amount of ink in the large-capacity ink container becomes less than a threshold value, the recording device switches an ink supply source to a reserve tank, which is an example of the liquid storage portion. The recording device continues a recording operation by supplying ink from the reserve tank when ink in the large-capacity ink container runs out.

JP-A-2015-116725 is an example of the related art.

When a remaining amount of liquid in the liquid storage portion falls below a threshold value, the liquid storage portion needs to be replaced or the liquid needs to be replenished. As disclosed in JP-A-2015-116725, when there are two liquid storage portions, after a remaining amount in one liquid storage portion falls below the threshold value and before a remaining amount in the other liquid storage portion falls below the threshold value, printing cannot be continued unless the liquid storage portion is replaced or liquid is replenished.

In order to enable printing for a long time after the remaining amount in the liquid storage portion falls below the threshold value, it is conceivable to increase the number of liquid storage portions. However, when there are a plurality of liquid storage portions capable of supplying liquid, there is room for improvement regarding which liquid storage portion is used next.

### SUMMARY

A method for controlling a liquid discharge device is a method for controlling a liquid discharge device including a liquid discharge head configured to discharge liquid, a mounting portion configured to allow three or more liquid storage portions storing the same type of liquid to be mounted thereon, and a remaining amount acquisition unit configured to acquire a remaining amount of liquid stored in each of the liquid storage portions. The method for controlling a liquid discharge device includes: using, for discharge, liquid stored in one of the three or more liquid storage portions mounted on the mounting portion; and when a remaining amount in one of the liquid storage portions used for discharge falls below a threshold value, using, for discharge, liquid stored in the liquid storage portion having a minimum remaining amount, which is a smallest remaining amount among the liquid storage portions each having a remaining amount equal to or greater than the threshold value.

A method for controlling a liquid discharge device is a method for controlling a liquid discharge device including a liquid discharge head configured to discharge liquid, a mounting portion configured to allow three or more liquid storage portions storing the same type of liquid to be mounted thereon, and a remaining amount acquisition unit configured to acquire a remaining amount of liquid stored in each of the liquid storage portions, in which each of the liquid storage portions includes a storage element configured to store information related to liquid to be stored, and the mounting portion includes at least one coupling portion that is electrically coupled to each of the storage elements. The method for controlling a liquid discharge device includes: acquiring, based on the information obtained via the coupling portion coupled to the storage element, a time limit for use of the liquid stored in each of the liquid storage portions; using, for discharge, liquid stored in one of the three or more liquid storage portions mounted on the mounting portion; and when a remaining amount in one of the liquid storage portions used for discharge falls below a threshold value, using, for discharge, liquid stored in the liquid storage portion having a shortest time limit closest to the time limit for use among the liquid storage portions each having a remaining amount equal to or greater than the threshold value.

A liquid discharge device includes: a liquid discharge head configured to discharge liquid; a mounting portion configured to allow three or more liquid storage portions storing the same type of liquid to be mounted thereon; a remaining amount acquisition unit configured to acquire a remaining amount of liquid stored in each of the liquid storage portions; and a control unit. The control unit performs control so as to, when a remaining amount in one of the liquid storage portions used for discharge falls below a threshold value, use, for discharge, liquid stored in the liquid storage portion having a smallest remaining amount among the liquid storage portions each having the remaining amount equal to or greater than the threshold value.

A liquid discharge device includes: a liquid discharge head configured to discharge liquid; a mounting portion configured to allow three or more liquid storage portions storing the same type of liquid to be mounted thereon; and a remaining amount acquisition unit configured to acquire a remaining amount of liquid stored in each of the liquid storage portions; and a control unit, and each of the liquid storage portions includes a storage element configured to store information related to liquid to be stored, the mounting portion includes at least one coupling portion that is electrically coupled to each of the storage elements, and the control unit performs control so as to acquire, based on the information obtained via the coupling portion coupled to the storage element, a time limit for use of the liquid stored in each of the liquid storage portions, and when a remaining amount in one of the liquid storage portions used for discharge falls below a threshold value, use, for discharge, liquid stored in the liquid storage portion having a closest time limit for use among the liquid storage portions each having a remaining amount equal to or greater than the threshold value.

### BRIEF DESCRIPTION OF THE DRAWINGS

FIG. 1 is a schematic diagram of a first embodiment of a liquid discharge device.

FIG. 2 is a flowchart showing a supply routine.

FIG. 3 is a flowchart showing a supply routine according to a second embodiment.

### DESCRIPTION OF EMBODIMENTS

### First Embodiment

Hereinafter, a first embodiment of a liquid discharge device and a method for controlling a liquid discharge device will be described with reference to the drawings. The liquid discharge device is, for example, an inkjet printer that discharges ink, which is an example of liquid, onto a medium such as paper, fabric, vinyl, plastic components, or metal components to perform printing.

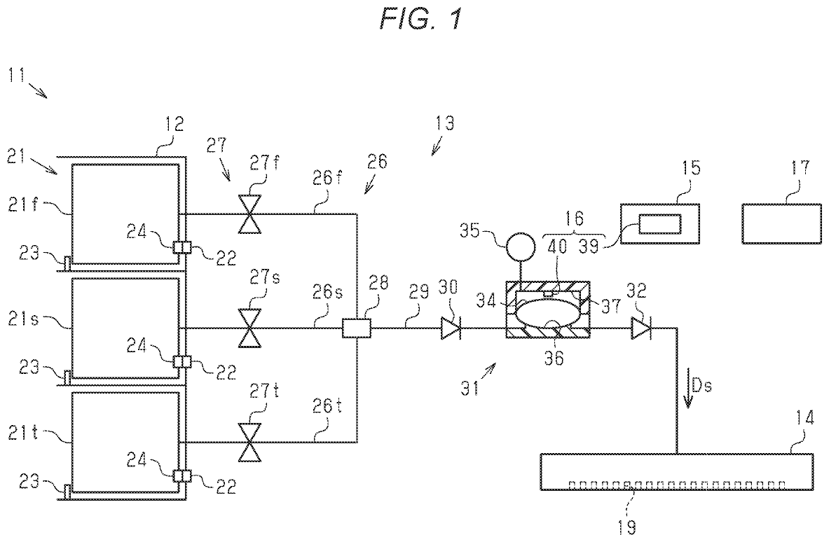

As shown in FIG. 1, a liquid discharge device 11 includes a mounting portion 12, a supply mechanism 13, a liquid discharge head 14, a control unit 15, and a remaining amount acquisition unit 16. The liquid discharge device 11 may include a notification unit 17.

The liquid discharge head 14 can discharge liquid. The liquid discharge head 14 discharges liquid from the plurality of nozzles 19 to print on a medium (not shown).

The notification unit 17 can notify information related to the liquid discharge device 11 to an outside. The notification unit 17 may be, for example, a display or a speaker.

### Mounting Portion

Three or more liquid storage portions 21 that store the same type of liquid can be mounted on the mounting portion 12. The mounting portion 12 may include one or more coupling portions 22 and one or more locking portions 23. A first liquid storage portion 21f, a second liquid storage portion 21s, and a third liquid storage portion 21t are mounted on the mounting portion 12 in FIG. 1. Each liquid storage portion 21 may include a storage element 24 that stores information related to stored liquid.

The liquid storage portion 21 may be a deformable bag body made of one or more film materials. Air is not supplied into the bag body, and when liquid is supplied from the liquid storage portion 21, the bag body contracts.

The storage element 24 may store, for example, a remaining amount of liquid stored in the liquid storage portion 21, and a manufacturing time of the liquid storage portion 21.

The coupling portion 22 is electrically coupled to the storage element 24. The liquid discharge device 11 may include the same number of coupling portions 22 as the number of the liquid storage portions 21 that can be mounted on the mounting portion 12. The coupling portion 22 is, for example, a terminal that can be coupled to the corresponding storage element 24.

The liquid discharge device 11 may include the same number of locking portions 23 as the number of the liquid storage portions 21 that can be mounted on the mounting portion 12. The locking portion 23 restricts the corresponding liquid storage portion 21 from being detached from the mounting portion 12. That is, the locking portion 23 restricts replacement of the liquid storage portion 21. For example, the locking portion 23 may restrict replacement of the liquid storage portion 21 during printing, and may permit replacement of the liquid storage portion 21 during standby in which printing is not performed.

### Supply Mechanism

The supply mechanism 13 may include three or more lead-out flow paths 26, three or more switching valves 27, a joint portion 28, a supply flow path 29, a first one-way valve 30, a supply pump 31, and a second one-way valve 32. The supply mechanism 13 supplies liquid from the liquid storage portion 21 mounted on the mounting portion 12 to the liquid discharge head 14 located downstream in a supply direction Ds.

The supply mechanism 13 includes the same number of lead-out flow paths 26 as the number of the liquid storage portions 21 that can be mounted on the mounting portion 12. The supply mechanism 13 in the embodiment includes a first lead-out flow path 26f, a second lead-out flow path 26s, and a third lead-out flow path 26t. An upstream end of the lead-out flow path 26 may be a hollow needle that penetrates the liquid storage portion 21 mounted on the mounting portion 12. Since the upstream end of the lead-out flow path 26 is coupled to the corresponding liquid storage portion 21, the liquid stored in the liquid storage portion 21 can be led out.

The supply mechanism 13 includes the same number of switching valves 27 as the number of the liquid storage portions 21 that can be mounted on the mounting portion 12. The supply mechanism 13 in the embodiment includes a first switching valve 27f, a second switching valve 27s, and a third switching valve 27t. The first switching valve 27f to the third switching valve 27t are respectively disposed in the first lead-out flow path 26f to the third lead-out flow path 26t.

The first switching valve 27f can switch a communication state of the first lead-out flow path 26f. When the first switching valve 27f is opened, the first liquid storage portion 21f communicates with the supply flow path 29 via the first lead-out flow path 26f. Communication means coupling a fluid such as liquid and gas in a flowable state. That is, when the first switching valve 27f is opened, liquid stored in the first liquid storage portion 21f can be used for discharge by the liquid discharge head 14. When the first switching valve 27f is closed, supply of the liquid from the first liquid storage portion 21f is stopped. Similarly, the second switching valve 27s can switch a supply state of liquid from the second liquid storage portion 21s. The third switching valve 27t can switch a supply state of liquid from the third liquid storage portion 21t.

The joint portion 28 couples downstream ends of the three or more lead-out flow paths 26 and an upstream end of the supply flow path 29.

The supply flow path 29 couples the joint portion 28 and the liquid discharge head 14.

The first one-way valve 30 and the second one-way valve 32 are provided in the supply flow path 29. The first one-way valve 30 is provided upstream of the second one-way valve 32 in the supply direction Ds. The first one-way valve 30 and the second one-way valve 32 allow the liquid to flow downstream in the supply direction Ds and restrict a flow of the liquid upstream.

The supply pump 31 is provided between the first one-way valve 30 and the second one-way valve 32. The supply pump 31 may include a diaphragm 34 and a drive unit 35. The supply pump 31 includes a pump chamber 36 and a pressure chamber 37.

The diaphragm 34 separates the pump chamber 36 from the pressure chamber 37. The diaphragm 34 changes a volume of the pump chamber 36 by moving in accordance with a difference in pressure between the pump chamber 36 and the pressure chamber 37.

The drive unit 35 can depressurize and pressurize the pressure chamber 37. The drive unit 35 depressurizes the pressure chamber 37 to increase the volume of the pump chamber 36, thereby sucking the liquid from the liquid storage portion 21 communicating with the supply flow path 29. The drive unit 35 pressurizes the pressure chamber 37 to reduce the volume of the pump chamber 36, thereby pressurizing liquid in the pump chamber 36 and supplying the liquid toward the liquid discharge head 14. For example, while power of the liquid discharge device 11 is on, the drive unit 35 may alternately repeatedly depressurize and pressurize the pressure chamber 37.

### Control Unit

The unit 15 collectively controls driving of each mechanism in the liquid discharge device 11, and controls various operations executed in the liquid discharge device 11.

The control unit 15 may be implemented as a circuit including a: one or more processors that execute various processes according to a computer program, B: one or more dedicated hardware circuits that execute at least some of the various processes, or y: a combination thereof. The hardware circuit is, for example, an application specific integrated circuit. The processor includes a CPU and a memory such as a RAM and a ROM. The memory stores program codes or commands configured to cause the CPU to execute a process. The memory, that is, a computer-readable medium includes any readable medium that can be accessed by a general-purpose or dedicated computer.

### Remaining Amount Acquisition Unit

The remaining amount acquisition unit 16 can acquire a remaining amount of liquid stored in each liquid storage portion 21. The remaining amount acquisition unit 16 may include a calculation unit 39 and a detection unit 40.

The control unit 15 may function as the calculation unit 39 by executing a program stored in the memory. The calculation unit 39 calculates, based on a consumption amount of liquid consumed by the liquid discharge head 14 discharging the liquid, an estimated remaining amount in the liquid storage portion 21 that supplies the liquid.

The liquid discharge device 11 consumes liquid by printing in which liquid is discharged from the liquid discharge head 14 onto a medium or by maintenance in which liquid is discharged from the liquid discharge head 14. For example, the calculation unit 39 may calculate the consumption amount based on a size and the number of discharged liquid droplets. For example, the calculation unit 39 may calculate the consumption amount according to a type of maintenance for discharging liquid from the liquid discharge head 14. The calculation unit 39 may calculate the estimated remaining amount by subtracting the consumption amount from the remaining amount stored in the storage element 24. The control unit 15 may store the calculated estimated remaining amount in the storage element 24.

The detection unit 40 physically detects liquid stored in at least one liquid storage portion 21. In the embodiment, a remaining amount detected by the detection unit 40 is also referred to as a physical remaining amount. The detection unit 40 in the embodiment detects the liquid through the diaphragm 34. Specifically, when liquid equal to or greater than a threshold value is stored in the liquid storage portion 21 used for discharge, the diaphragm 34 moves so as to increase the volume of the pump chamber 36 as the pressure chamber 37 is depressurized. Therefore, the detection unit 40 can detect that, by detecting a movement of the diaphragm 34, the physical remaining amount in the liquid storage portion 21 used for the discharge is equal to or greater than the threshold value. The threshold value in the embodiment is the smallest amount at which liquid can be supplied from the liquid storage portion 21.

When the physical remaining amount in the liquid storage portion 21 falls below the threshold value, liquid cannot be supplied from the liquid storage portion 21. When liquid cannot be supplied, the diaphragm 34 cannot move to increase the volume of the pump chamber 36 when the pressure chamber 37 is depressurized. That is, when the physical remaining amount in the liquid storage portion 21 falls below the threshold value, the detection unit 40 cannot detect the diaphragm 34 that increases the volume of the pump chamber 36. Therefore, the detection unit 40 can detect whether the physical remaining amount in the liquid storage portion 21 used for the discharge is equal to or greater than the threshold value or falls below the threshold value. When the detection unit 40 detects that the physical remaining amount falls below the threshold value, the control unit 15 may store supply failure information in the storage element 24 of the liquid storage portion 21 in use.

### Supply Routine

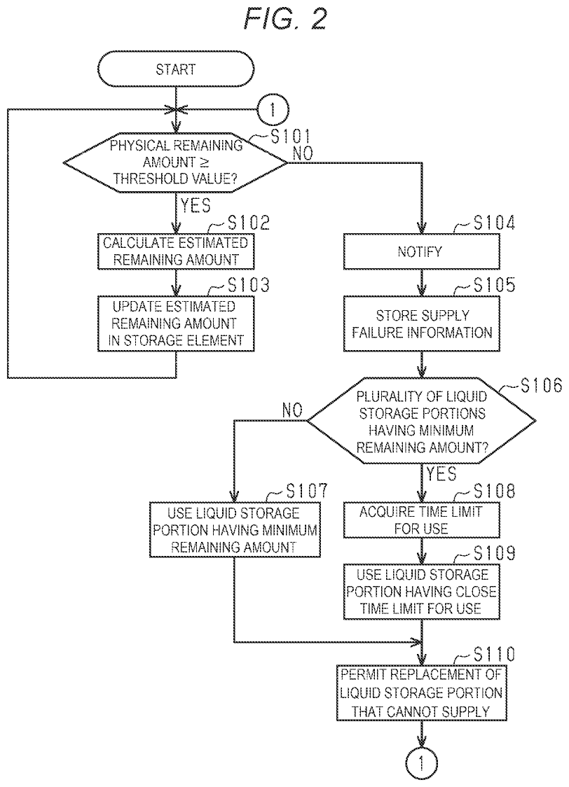

A method for controlling the liquid discharge device 11 will be described with reference to a flowchart shown in FIG. 2.

A supply routine is executed at a timing at which liquid is consumed by the liquid discharge head 14, for example, during printing. When the supply routine is executed, one of the switching valves 27 is opened. That is, the control method includes using, for discharge, the liquid stored in one of the three or more liquid storage portions 21 mounted on the mounting portion 12.

In step S101, the control unit 15 may determine whether the physical remaining amount is equal to or greater than the threshold value based on a detection result of the detection unit 40. The control method may include physically detecting, by the detection unit 40, liquid stored in at least one liquid storage portion 21 to acquire the physical remaining amount in the liquid storage portion 21. When the physical remaining amount is equal to or greater than the threshold value, the determination in step S101 is YES, and the control unit 15 causes the process to proceed to step S102.

In step S102, the control unit 15 may cause the calculation unit 39 to calculate an estimated remaining amount in the liquid storage portion 21 used for discharge. The control method may include acquiring the estimated remaining amount in at least one liquid storage portion 21 by the calculation unit 39.

In step S103, the control unit 15 may update the estimated remaining amount stored in the storage element 24 of the liquid storage portion 21 used for discharge with the calculated estimated remaining amount. The control unit 15 causes the process to proceed to step S101.

In step S101, when the physical remaining amount in the liquid storage portion 21 used for the discharge falls below the threshold value, the determination in step S101 is NO, and the control unit 15 causes the process to proceed to step S104.

In step S104, the control unit 15 may cause the notification unit 17 to notify that the remaining amount in the liquid storage portion 21 used for discharge falls below the threshold value. The control method may include notifying the outside that the remaining amount in one liquid storage portion 21 used for discharge falls below the threshold value.

In step S105, the control unit 15 may cause the storage element 24 of the liquid storage portion 21 used for discharge to store the supply failure information.

In step S106, the control unit 15 may compare remaining amounts in the liquid storage portions 21 having the remaining amount equal to or greater than the threshold value. The control unit 15 in the embodiment compares estimated remaining amounts in the liquid storage portions 21 having the physical remaining amount equal to or greater than the threshold value. When there is only one liquid storage portion 21 having the minimum remaining amount, which is the smallest estimated remaining amount among the liquid storage portions 21 having the physical remaining amount equal to or greater than the threshold value, the determination in step S106 is NO, and the control unit 15 causes the process to proceed to step S107.

In step S107, the control unit 15 may use, for discharge, the liquid storage portion 21 having a minimum remaining amount among the liquid storage portions 21 having the physical remaining amount equal to or greater than the threshold value. The control method may include, when the physical remaining amount in one liquid storage portion 21 used for discharge falls below the threshold value, using, for discharge, the liquid stored in the liquid storage portion 21 having the minimum remaining amount among the liquid storage portions 21 having the physical remaining amount equal to or greater than the threshold value. The control unit 15 closes the switching valve 27 that was opened earlier and opens the switching valve 27 corresponding to the liquid storage portion 21 having the minimum remaining amount. When there are a plurality of liquid storage portions 21 having the minimum remaining amount, the determination in step S106 is YES, and the control unit 15 causes the process to proceed to step S108.

In step S108, the control unit 15 may acquire a time limit for use of the liquid storage portion 21 having the minimum remaining amount. The control method may include acquiring, based on information obtained via the coupling portion 22 coupled to the storage element 24, a time limit for use of the liquid stored in each liquid storage portion 21. The time limit for use may be acquired from the time limit for use stored in the storage element 24, or may be acquired based on time information such as a manufacturing time stored in the storage element 24.

In step S109, the control unit 15 may use, for discharge, the liquid storage portion 21 having the closest time limit for use among the liquid storage portions 21 having the minimum remaining amount. That is, the control method may include, when the physical remaining amount in one liquid storage portion 21 used for discharge falls below the threshold value and there are a plurality of liquid storage portions 21 having the minimum remaining amount, using, for discharge, the liquid stored in the liquid storage portion 21 having the closest time limit for use among the plurality of liquid storage portions 21. The control unit 15 closes the switching valve 27 that was opened earlier and opens the switching valve 27 corresponding to the liquid storage portion 21 to be used.

In step S110, the control unit 15 may release a restriction of replacement of the liquid storage portion 21 by the locking portion 23, for the liquid storage portion 21 in which the physical remaining amount falls below the threshold value and the liquid cannot be supplied. The control method may include enabling replacement of the liquid storage portion 21 when the physical remaining amount in one liquid storage portion 21 used for discharge falls below the threshold value during discharge of liquid by the liquid discharge head 14. The control unit 15 causes the process to proceed to step S101.

### Operation of First Embodiment

An operation of the embodiment will be described.

All the switching valves 27 may be closed while the power of the liquid discharge device 11 is off. When the power of the liquid discharge device 11 is on, the control unit 15 opens one switching valve 27.

For example, the control unit 15 may check whether the physical remaining amount is equal to or greater than the threshold value in order from the first liquid storage portion 21f, and may open the switching valve 27 corresponding to the liquid storage portion 21 for which it is first confirmed that the physical remaining amount is equal to or greater than the threshold value. The control unit 15 may check whether the supply failure information is stored in order from the first liquid storage portion 21f, and may open the switching valve 27 corresponding to the liquid storage portion 21 for which it is first confirmed that the supply failure information is not stored. The control unit 15 may open the switching valve 27 corresponding to the liquid storage portion 21 having the minimum remaining amount among the liquid storage portions 21 having the physical remaining amount equal to or greater than the threshold value. The control unit 15 may open the switching valve 27 corresponding to the liquid storage portion 21 that was used last time. The control unit 15 may open the switching valve 27 corresponding to the liquid storage portion 21 having the closest time limit for use among the liquid storage portions 21 having the physical remaining amount equal to or greater than the threshold value. The control unit 15 may open the switching valve 27 corresponding to the liquid storage portion 21 designated by a user. By opening one switching valve 27, liquid can be supplied from one liquid storage portion 21 to the liquid discharge head 14.

When there is a liquid storage portion 21 in which the physical remaining amount falls below the threshold value, the control unit 15 may notify the liquid storage portion 21 to be replaced using the notification unit 17. The control unit 15 may release lock by the locking portion 23 for the liquid storage portion 21 in which the physical remaining amount falls below the threshold value. When the liquid storage portion 21 is replaced, the control unit 15 may cause the locking portion 23 to restrict detachment of the mounted liquid storage portion 21 from the mounting portion 12.

When the liquid is consumed in the liquid discharge head 14, a remaining amount in the liquid storage portion 21 used for discharge is reduced. When the estimated remaining amount in the liquid storage portion 21 used for discharge falls below a notification threshold value, the control unit 15 may cause the notification unit 17 to notify that the liquid storage portion 21 used for discharge is to be switched soon, whether there is a switchable liquid storage portion 21, and the like. A notification remaining amount is larger than a threshold value used for comparison with the physical remaining amount.

When the physical remaining amount in one liquid storage portion 21 used for discharge falls below the threshold value, the control unit 15 performs control so as to use, for discharge, the liquid stored in the liquid storage portion 21 having the smallest estimated remaining amount among the liquid storage portions 21 having the physical remaining amount equal to or greater than the threshold value.

### Effects of First Embodiment

Effects of the embodiment will be described.

(1-1) When the physical remaining amount in one liquid storage portion 21 that was used earlier for discharge falls below the threshold value, the liquid stored in the liquid storage portion 21 having the minimum remaining amount among the other liquid storage portions 21 having the remaining amount equal to or greater than the threshold value is switched to be used for discharge. In general, it can be estimated that the liquid storage portion 21 having a small remaining amount is manufactured earlier than the liquid storage portion 21 having a large remaining amount. Therefore, by preferentially using the liquid storage portion 21 having a small remaining amount, three or more liquid storage portions 21 can be appropriately used.

(1-2) When there are a plurality of liquid storage portions 21 having the minimum remaining amount, the liquid storage portion 21 having a close time limit for use is preferentially used. Therefore, the liquid in the liquid storage portion 21 can be easily used up within the time limit for use.

(1-3) The notification unit 17 notifies the outside that the physical remaining amount in the liquid storage portion 21 falls below the threshold value. Therefore, for example, the user can easily determine whether to respond to the liquid storage portion 21 in which the physical remaining amount falls below the threshold value.

(1-4) When the physical remaining amount in the liquid storage portion 21 in use falls below the threshold value during discharge of liquid by the liquid discharge head 14, the liquid storage portion 21 can be replaced. Since it is possible to cope with the liquid storage portion 21 even during discharge of liquid, it is possible to flexibly cope with the liquid storage portion 21.

(1-5) The remaining amount acquisition unit 16 acquires, by the detection unit 40, the physical remaining amount by physically detecting the liquid stored in at least one liquid storage portion 21. Therefore, an error between an actual remaining amount and the acquired physical remaining amount can be reduced.

(1-6) The remaining amount acquisition unit 16 calculates, based on the consumption amount of the liquid consumed by the liquid discharge head 14, the estimated remaining amount of the liquid stored in the liquid storage portion 21. Therefore, the remaining amount of the liquid stored in the liquid storage portion 21 can be easily estimated.

(1-7) When the physical remaining amount in the liquid storage portion 21 used for discharge falls below the threshold value, the liquid stored in the liquid storage portion 21 having the smallest estimated remaining amount is switched to be used for discharge. Therefore, use of the liquid storage portion 21 that was used earlier for discharge can be suspended based on the physical remaining amount having a small error from the actual remaining amount. The liquid storage portion 21 to be used next can be easily selected based on the estimated remaining amount.

### Second Embodiment

Next, a second embodiment of the liquid discharge device and the method for controlling a liquid discharge device will be described with reference to the drawings. The second embodiment differs from the first embodiment in a supply routine. Since the second embodiment is substantially the same as the first embodiment in other points, the same components are denoted by the same reference signs, and a redundant description thereof will be omitted.

### Supply Routine

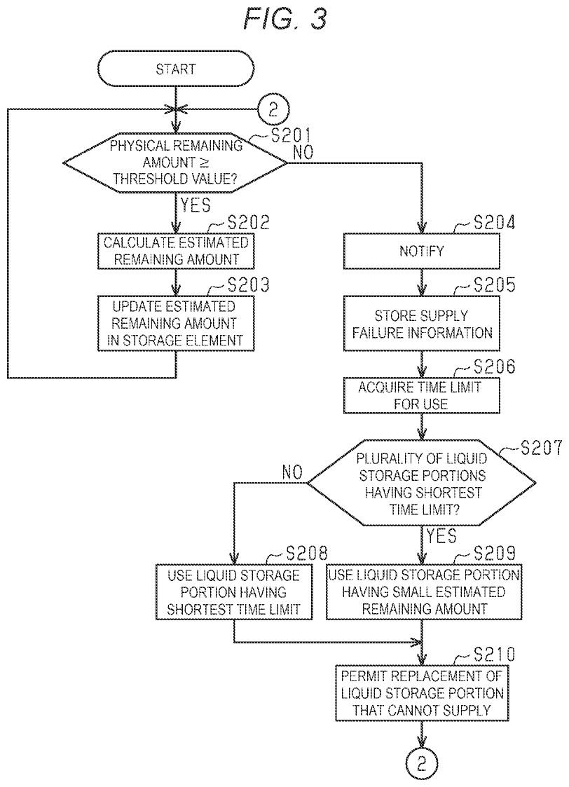

Since processes of steps S201 to S205 shown in FIG. 3 is the same as the processes of steps S101 to S105 shown in FIG. 2, the description thereof will be omitted.

In step S206, the control unit 15 may acquire a time limit for use of liquid stored in the liquid storage portion 21 mounted on the mounting portion 12. The control unit 15 may acquire a time limit for use of the liquid storage portion 21 having the physical remaining amount equal to or greater than the threshold value. The control method may include acquiring, based on information obtained via the coupling portion 22 coupled to the storage element 24, a time limit for use of the liquid stored in each liquid storage portion 21.

In step S207, the control unit 15 determines whether there are a plurality of liquid storage portions 21 having the shortest time limit closest to the time limit for use among the liquid storage portions 21 having the physical remaining amount equal to or greater than the threshold value. When there is one liquid storage portion 21 having the shortest time limit, determination in step S207 is NO, and the control unit 15 causes the process to proceed to step S208.

In step S208, the control unit 15 may use, for discharge, the liquid storage portion 21 having the shortest time limit among the liquid storage portions 21 having the physical remaining amount equal to or greater than the threshold value. The control method includes, using, for discharge, when the physical remaining amount in one liquid storage portion 21 used for discharge falls below the threshold value, the liquid stored in the liquid storage portion 21 having the shortest time limit closest to the time limit for use among the liquid storage portions 21 having the physical remaining amount equal to or greater than the threshold value. The control unit 15 closes the switching valve 27 that was opened earlier and opens the switching valve 27 corresponding to the liquid storage portion 21 having the shortest time limit.

When there are a plurality of liquid storage portions 21 having the shortest time limit, the determination in step S207 is YES, and the control unit 15 causes the process to proceed to step S209.

In step S209, the control unit 15 may use, for discharge, the liquid storage portion 21 having the minimum remaining amount among the liquid storage portions 21 having the shortest time limit. That is, the control method may include, when the physical remaining amount in one liquid storage portion 21 used for discharge falls below the threshold value and there are a plurality of liquid storage portions 21 having the shortest time limit, using, for discharge, the liquid stored in the liquid storage portion 21 having the physical remaining amount equal to or greater than the threshold value and having the smallest estimated remaining amount among the liquid storage portions 21 having the shortest time limit. The control unit 15 closes the switching valve 27 that was opened earlier and opens the switching valve 27 corresponding to the liquid storage portion 21 to be used.

In step S210, the control unit 15 executes a similar process as in step S110 in FIG. 2.

The control unit 15 causes the process to proceed to step S201.

### Operation of Second Embodiment

An operation of the embodiment will be described.

The control unit 15 acquires, based on information obtained via the coupling portion 22 coupled to the storage element 24, a time limit for use of the liquid stored in each liquid storage portion 21. The control unit 15 performs control so as to, when the physical remaining amount in one liquid storage portion 21 used for discharge falls below the threshold value, use, for discharge, the liquid stored in the liquid storage portion 21 having the closest time limit for use among the liquid storage portions 21 having the physical remaining amount equal to or greater than the threshold value.

### Effects of Second Embodiment

Effects of the embodiment will be described.

(2-1) When the physical remaining amount in one liquid storage portion 21 that was used earlier for discharge falls below the threshold value, the liquid stored in the liquid storage portion 21 having the closest time limit for use among the other liquid storage portions 21 having the remaining amount equal to or greater than the threshold value is switched to be used for discharge. Therefore, by preferentially using the liquid storage portion 21 having a close time limit for use, the liquid in the liquid storage portion 21 can be easily used up within the time limit for use, and three or more liquid storage portions 21 can be appropriately used.

(2-2) When there are a plurality of liquid storage portions 21 having the shortest time limit, the liquid storage portion 21 having a small estimated remaining amount is preferentially used. By using the liquid storage portion 21 having a small remaining amount, a timing at which the remaining amount falls below the threshold value can be brought earlier than when using the liquid storage portion 21 having a large remaining amount. Therefore, since it is easy to ensure a time corresponding to the liquid storage portion 21 in which the physical remaining amount falls below the threshold value, usability can be improved.

(2-3) When there are a plurality of liquid storage portions 21 having the shortest time limit, the liquid storage portion 21 having a small estimated remaining amount is preferentially used. Therefore, the liquid storage portion 21 to be used next can be easily selected based on the estimated remaining amount.

### Modification

The embodiment can be implemented with the following modifications. The embodiment and the following modification can be implemented in combination with each other within a technically consistent range.
When the liquid storage portion 21 has a bag shape, the detection unit 40 may acquire a physical remaining amount by detecting a thickness of the liquid storage portion 21.
The detection unit 40 may acquire the physical remaining amount by detecting a weight of the liquid storage portion 21.
The liquid storage portion 21 may have a box shape having rigidity. A liquid surface may be formed in the liquid storage portion 21. An atmospheric pressure may act on the liquid surface.
A part of the lead-out flow path 26 may be formed of a flexible film having flexibility. The detection unit 40 may physically detect the liquid via the flexible film. The remaining amount acquisition unit 16 may include the same number of detection units 40 as the number of the lead-out flow paths 26. The detection unit 40 may detect bulging of the flexible film. The atmospheric pressure acts on the liquid surface of the liquid stored in the liquid storage portion 21 and the flexible film. When the liquid surface of the liquid stored in the liquid storage portion 21 is located above the flexible film in a vertical direction, the flexible film bulges so as to widen the lead-out flow path 26. When an amount of liquid stored in the liquid storage portion 21 decreases, the flexible film is recessed to narrow the lead-out flow path 26. The flexible films may be arranged side by side in a horizontal direction at the same position in the vertical direction with respect to the liquid storage portion 21, or may be arranged below the liquid storage portion 21 in the vertical direction. The detection unit 40 may detect that, by detecting the bulged flexible film, the physical remaining amount in the corresponding liquid storage portion 21 is equal to or greater than the threshold value. The detection unit 40 may detect that, by detecting the recessed flexible film, the physical remaining amount in the corresponding liquid storage portion 21 falls below the threshold value. That is, the threshold value may be an amount by which the flexible film can be bulged.
The detection unit 40 may acquire the physical remaining amount by detecting a position of the liquid surface in the liquid storage portion 21. The threshold value may be a height of the liquid surface. The detection unit 40 may detect that, by detecting a liquid surface located at a position higher than the threshold value, the physical remaining amount is equal to or greater than the threshold value. The detection unit 40 may detect that, by detecting a liquid surface located at a position lower than the threshold value, the physical remaining amount falls below the threshold value.
The detection unit 40 may include a plurality of electrodes having different lengths. The plurality of electrodes may be provided at predetermined positions in the liquid storage portion 21. The detection unit 40 may detect a position of the liquid surface by detecting resistance that changes between a case where the liquid is in contact with the electrode and a case where the liquid is not in contact with the electrode.
The detection unit 40 may include a prism, an irradiation unit, and a light reception unit. The prism is provided in the liquid storage portion 21. The irradiation unit irradiates the prism with light. The light reception unit receives light refracted by the prism. While the liquid is in contact with the prism, the light diffuses into the liquid. When the liquid surface is located below the prism and the prism is exposed from the liquid, the light refracted by the prism reaches the light reception unit. The detection unit 40 may detect a position of the liquid surface based on a change in an amount of light received by the light reception unit.
The detection unit 40 may be a float sensor that is provided in the liquid storage portion 21 and detects a position of a float floating on the liquid.
The detection unit 40 may be an image sensor that detects an image. The remaining amount acquisition unit 16 may acquire a position of the liquid surface by analyzing the image detected by the image sensor.
The detection unit 40 may be a photoelectric sensor including a light emitting unit that emits light and a light reception unit that receives light. The light emitting unit and the light reception unit may be provided with the liquid storage portion 21 interposed therebetween. The light reception unit may receive light transmitted through the liquid storage portion 21. For example, when the liquid surface is above the photoelectric sensor, the light is blocked by the liquid existing between the light emitting unit and the light reception unit. The detection unit 40 may detect a position of the liquid surface based on a change in an amount of light received by the light reception unit.
The control unit 15 may use, for discharge, when the estimated remaining calculated by the calculation unit 39 falls below the threshold value, the liquid stored in the liquid storage portion 21 in which the physical remaining amount detected by the detection unit 40 is equal to or greater than the threshold value and the physical remaining amount is the smallest.
The control unit 15 may use, for discharge, when the estimated remaining amount calculated by the calculation unit 39 falls below the threshold value, the liquid stored in the liquid storage portion 21 having the shortest time limit.
The control unit 15 may use, for discharge, when the estimated remaining amount falls below the threshold value and there are a plurality of liquid storage portions 21 having the shortest time limit, the liquid stored in the liquid storage portion 21 having the physical remaining amount equal to or greater than the threshold value and having the smallest physical remaining amount among the liquid storage portions 21 having the shortest time limit.
The remaining amount acquisition unit 16 may include one of the detection unit 40 and the calculation unit 39.
The control unit 15 may use, for discharge, when the physical remaining amount acquired by the detection unit 40 falls below the threshold value, the liquid stored in the liquid storage portion 21 having the physical remaining amount equal to or greater than the threshold value and having the smallest physical remaining amount.
The control unit 15 may use, for discharge, when the estimated remaining amount calculated by the calculation unit 39 falls below the threshold value, the liquid stored in the liquid storage portion 21 having the calculated remaining amount equal to or greater than the threshold value and having the smallest calculated remaining amount.
When the remaining amount in one liquid storage portion 21 used for discharge falls below the threshold value, the user may select, for example, whether to preferentially use the liquid storage portion 21 having a small remaining amount or to preferentially use the liquid storage portion 21 having a close time limit for use.
For example, when there is a liquid storage portion 21 whose time limit for use is shorter than a set time limit, the control unit 15 may preferentially use the liquid storage portion 21 whose time limit for use is shorter than the set time limit. When there is no liquid storage portion 21 whose time limit for use is shorter than the set time limit, the control unit 15 may preferentially use the liquid storage portion 21 whose remaining amount is small. The set time limit may be a preset period such as one month, or may be set in accordance with a frequency of use of the liquid discharge device 11.
The storage element 24 may store amount information such as a maximum storage amount of the liquid that can be stored in the liquid storage portion 21, an initial storage amount stored at the time of shipment, and a supply amount of the liquid supplied from the liquid storage portion 21. The calculation unit 39 may calculate the estimated remaining amount based on the amount information.
The storage element 24 may store the time limit for use of the liquid storage portion 21.
The storage element 24 may store time information such as a filling time at which the liquid storage portion 21 filled the liquid, a is with manufacturing time of the liquid storage portion 21, and a shipping time of the liquid storage portion 21. When the remaining amount in one liquid storage portion 21 used for discharge falls below the threshold value, the control unit 15 may preferentially use the liquid storage portion 21 having the earliest filling time, manufacturing time, shipping time, or the like among the liquid storage portions 21 having the remaining amount equal to or greater than the threshold value.
The storage element 24 may store the number of times the liquid storage portion 21 is attached to and detached from the mounting portion 12. When the remaining amount in one liquid storage portion 21 used for discharge falls below the threshold value, the control unit 15 may preferentially use the liquid storage portion 21 having the largest number of times of mounting among the liquid storage portions 21 having the remaining amount equal to or greater than the threshold value.
The liquid storage portion 21 may be replenished with liquid. When liquid replenishment is possible, the liquid storage portion 21 may be fixed to the mounting portion 12. When the remaining amount in the liquid storage portion 21 falls below the threshold value, the control unit 15 may cause the notification unit 17 to notify the liquid storage portion 21 to replenish the liquid.
Among the three or more liquid storage portions 21 that store the same type of liquid, at least one liquid storage portion 21 may store a different amount of liquid.
The mounting portion 12 may be divided into a plurality of portions. In other words, the liquid discharge device 11 may include a plurality of mounting portions 12 on which one or more liquid storage portions 21 storing the same type of liquid are mounted. Three or more liquid storage portions 21 that store the same type of liquid may be separately mounted on a plurality of mounting portions 12. The plurality of mounting portions 12 may be provided apart from each other. For example, the plurality of mounting portions 12 may be provided inside and outside the liquid discharge device 11.
The notification unit 17 may give a notification of information related to each liquid storage portion 21. For example, the notification unit 17 may give a notification of the remaining amount in each liquid storage portion 21.
The liquid discharge device 11 may include a plurality of mounting portions 12 and a plurality of supply mechanisms 13. The plurality of mounting portions 12 may be mounted with the liquid storage portions 21 that store different types of liquid for each mounting portion 12. For example, the liquid storage portion 21 that stores black ink may be mounted on the first mounting portion 12. The liquid storage portion 21 that stores white ink may be mounted on the second mounting portion 12. The liquid discharge device 11 may be capable of color printing using a plurality of types of ink.
When the liquid discharge device 11 includes a plurality of mounting portions 12, three or more liquid storage portions 21 that store the same type of liquid may be mounted on the mounting portion 12.
When the liquid discharge device 11 includes a plurality of mounting portions 12, the plurality of mounting portions 12 may have different numbers of liquid storage portions 21 that can be mounted. For example, three or more liquid storage portions 21 that store the same type of liquid may be mounted on one mounting portion 12. One or two liquid storage portions 21 may be mounted on the other mounting portion 12.
The coupling portion 22 may read information stored in the storage element 24 by communicating with the storage element 24 in a non-contact manner. One coupling portion 22 may read information stored in a plurality of storage elements 24.
The liquid discharge device 11 may include a cover that covers the liquid storage portion 21 mounted on the mounting portion 12. The locking portion 23 may restrict opening of the cover. The locking portion 23 may enable replacement of the liquid storage portion 21 by permitting opening of the cover.
The liquid discharge device 11 may not include the locking portion 23. For example, the control unit 15 may stop discharge of liquid by the liquid discharge head 14 when the storage element 24 is separated from the coupling portion 22. The control unit 15 may enable the replacement of the liquid storage portion 21 by causing the liquid discharge head 14 to continue discharging the liquid, even when the storage element 24 of the liquid storage portion 21 in which the remaining amount falls below the threshold value is separated from the coupling portion 22.
The control unit 15 may cause the notification unit 17 to give a notification when remaining amounts in the plurality of liquid storage portions 21 fall below the threshold value.
The liquid discharge device 11 may be a liquid discharge device that ejects or discharges liquid other than ink. A state of liquid discharged as a minute amount of liquid droplet from the liquid discharge device includes a state in which a tail is drawn in a particle shape, a tear shape, or a thread shape. Here, the liquid may be a material that can be discharged from the liquid discharge device. For example, the liquid may be in a state when a substance is in a liquid phase, and includes a fluid such as having high or low viscosity liquid, sol, gel water, other inorganic solvents, organic solvents, solutions, liquid resins, liquid metals, and metal melt. The liquid includes not only liquid in a state of a substance but also liquid in which particles of a functional material made of a solid such as a pigment or a metal particle are dissolved, dispersed, or mixed in a solvent. Typical examples of the liquid include ink and liquid crystal as described in the above embodiment. Here, the ink includes various types of liquid compositions such as general water-based ink, oil-based ink, gel ink, and hot melt ink. As a specific example of the liquid discharge device, for example, there is a device that discharges liquid containing a material such as an electrode material or a coloring material used for manufacturing a liquid crystal display, an electroluminescence display, a surface-emitting display, a color filter, or the like in a dispersed or dissolved form. The liquid discharge device may be a device that discharges a bioorganic substance used for manufacturing a biochip, a device that is used as a precision pipette and discharges liquid as a sample, a textile printing device, a micro dispenser, or the like. The liquid discharge device may be a device that discharges lubricating oil to a precision machine such as a timepiece or a camera in a pinpoint manner, or a device that discharges transparent resin liquid such as ultraviolet curable resin onto a substrate in order to form a minute hemispherical lens, an optical lens, or the like used for an optical communication element or the like. The liquid discharge device may be a device that discharges an etching solution such as acid or alkali in order to etch a substrate or the like.

### Definition

The expression “at least one” used in the specification means “one or more” of desired options. For example, the expression “at least one” used in the specification means “only one option” or “both of two options” when the number of options is two. As another example, the expression “at least one” used in the specification means “only one option” or “a combination of any two or more options” when the number of options is three or more.

### APPENDIXES

In the following description, technical ideas understood from the embodiment and the modification described above and operational effects thereof will be described.

(A) A method for controlling a liquid discharge device including a liquid discharge head configured to discharge liquid, a mounting portion configured to allow three or more liquid storage portions storing the same type of liquid to be mounted thereon, and a remaining amount acquisition unit configured to acquire a remaining amount of liquid stored in each of the liquid storage portions, the method for controlling a liquid discharge device including: using, for discharge, liquid stored in one of the three or more liquid storage portions mounted on the mounting portion; and when a remaining amount in one of the liquid storage portions used for discharge falls below a threshold value, using, for discharge, liquid stored in the liquid storage portion having a minimum remaining amount, which is a smallest remaining amount among the liquid storage portions each having a remaining amount equal to or greater than the threshold value.

According to this method, when the remaining amount in one liquid storage portion that was used earlier for discharge falls below the threshold value, the liquid stored in the liquid storage portion having the minimum remaining amount among the other liquid storage portions having the remaining amount equal to or greater than the threshold value is switched to be used for discharge. In general, it can be estimated that the liquid storage portion having a small remaining amount is manufactured earlier than the liquid storage portion having a large remaining amount. Therefore, by preferentially using the liquid storage portion having a small remaining amount, three or more liquid storage portions can be appropriately used.

(B) In the method for controlling a liquid discharge device according to (A), each of the liquid storage portions may include a storage element configured to store information related to liquid to be stored, and the mounting portion may include at least one coupling portion that is electrically coupled to each of the storage elements, and the method for controlling a liquid discharge device may further include: acquiring, based on the information obtained via the coupling portion coupled to the storage element, a time limit for use of the liquid stored in each of the liquid storage portions; and when a remaining amount in one of the liquid storage portions used for the discharge falls below the threshold value and there are a plurality of the liquid storage portions each having the minimum remaining amount, using, for discharge, liquid stored in the liquid storage portion having a closest time limit for use among the plurality of liquid storage portions.

According to this method, when there are a plurality of liquid storage portions having the minimum remaining amount, the liquid storage portion having a close time limit for use is preferentially used. Therefore, the liquid in the liquid storage portion can be easily used up within the time limit for use.

(C) A method for controlling a liquid discharge device including a liquid discharge head configured to discharge liquid, a mounting portion configured to allow three or more liquid storage portions storing the same type of liquid to be mounted thereon, and a remaining amount acquisition unit configured to acquire a remaining amount of liquid stored in each of the liquid storage portions, in which each of the liquid storage portions includes a storage element configured to store information related to liquid to be stored, and the mounting portion includes at least one coupling portion that is electrically coupled to each of the storage elements, the method for controlling a liquid discharge device including: acquiring, based on the information obtained via the coupling portion coupled to the storage element, a time limit for use of the liquid stored in each of the liquid storage portions; using, for discharge, liquid stored in one of the three or more liquid storage portions mounted on the mounting portion; and when a remaining amount in one of the liquid storage portions used for discharge falls below a threshold value, using, for discharge, liquid stored in the liquid storage portion having a shortest time limit closest to the time limit for use among the liquid storage portions each having a remaining amount equal to or greater than the threshold value.

According to this method, when the remaining amount in one liquid storage portion that was used earlier for discharge falls below the threshold value, the liquid stored in the liquid storage portion having the closest time limit for use among the other liquid storage portions having the remaining amount equal to or greater than the threshold value is switched to be used for discharge. Therefore, by preferentially using the liquid storage portion having a close time limit for use, the liquid in the liquid storage portion can be easily used up within the time limit for use, and three or more liquid storage portions can be appropriately used.

(D) The method for controlling a liquid discharge device according to (C) may further include: when a remaining amount in one of the liquid storage portions used for discharge falls below the threshold value and there are a plurality of the liquid storage portions each having the shortest time limit, using, for discharge, liquid stored in the liquid storage portion having a remaining amount equal to or greater than the threshold value and having a smallest remaining amount among the liquid storage portions each having the shortest time limit.

According to this method, when there are a plurality of liquid storage portions having the shortest time limit, the liquid storage portion having a small remaining amount is preferentially used. By using the liquid storage portion having a small remaining amount, a timing at which the remaining amount falls below the threshold value can be brought earlier than when using the liquid storage portion having a large remaining amount. Therefore, since it is easy to ensure a time corresponding to the liquid storage portion in which the remaining amount falls below the threshold value, usability can be improved.

(E) The method for controlling a liquid discharge device according to any one of (A) to (D) may further include: notifying an outside that a remaining amount in one of the liquid storage portions used for discharge falls below the threshold value.

According to this method, it is notified to the outside that the remaining amount in the liquid storage portion falls below the threshold value. Therefore, for example, the user can easily determine whether to respond to the liquid storage portion in which the remaining amount falls below the threshold value.

(F) The method for controlling a liquid discharge device according to any one of (A) to (E) may further include: enabling replacement of the liquid storage portion when a remaining amount in one of the liquid storage portions used for discharge falls below the threshold value during discharge of liquid by the liquid discharge head.

According to this method, when the remaining amount in the liquid storage portion in use falls below the threshold value during discharge of liquid by the liquid discharge head, the liquid storage portion can be replaced. Since it is possible to cope with the liquid storage portion even during discharge of liquid, it is possible to flexibly cope with the liquid storage portion.

(G) In the method for controlling a liquid discharge device according to any one of (A) to (F), the remaining amount acquisition unit may include a detection unit configured to physically detect liquid stored in at least one of the liquid storage portions, and the method for controlling a liquid discharge device may further include: physically detecting, by the detection unit, liquid stored in at least one of the liquid storage portions to acquire a physical remaining amount in the liquid storage portion.

According to this method, the remaining amount acquisition unit acquires, by the detection unit, the physical remaining amount by physically detecting the liquid stored in at least one of the liquid storage portions. Therefore, an error between an actual remaining amount and the acquired physical remaining amount can be reduced.

(H) In the method for controlling a liquid discharge device according to any one of (A) to (G), the remaining amount acquisition unit may include a calculation unit configured to calculate, based on a consumption amount of liquid consumed by the liquid discharge head discharging liquid, an estimated remaining amount in the liquid storage portion that supplies liquid, and the method for controlling a liquid discharge device may further include: acquiring, by the calculation unit, the estimated remaining amount in at least one of the liquid storage portions.

According to this method, the remaining amount acquisition unit calculates, based on the consumption amount of the liquid consumed by the liquid discharge head, the estimated remaining amount of the liquid stored in the liquid storage portion. Therefore, the remaining amount of the liquid stored in the liquid storage portion can be easily estimated.

(I) In the method for controlling a liquid discharge device according to (A), the remaining amount acquisition unit may include a detection unit configured to physically detect liquid stored in at least one of the liquid storage portions, and a calculation unit configured to calculate, based on a consumption amount of liquid consumed by the liquid discharge head discharging liquid, an estimated remaining amount in the liquid storage portion that supplies liquid, and the method for controlling a liquid discharge device may further include: physically detecting, by the detection unit, liquid stored in at least one of the liquid storage portions to acquire a physical remaining amount in the liquid storage portion; acquiring, by the calculation unit, the estimated remaining amount in at least one of the liquid storage portions; and when the physical remaining amount in one of the liquid storage portions used for discharge falls below the threshold value, using, for discharge, liquid stored in the liquid storage portion having a smallest estimated remaining amount among the liquid storage portions each having the physical remaining amount equal to or greater than the threshold value.

According to this method, when the physical remaining amount in the liquid storage portion used for discharge falls below the threshold value, the liquid stored in the liquid storage portion having the smallest estimated remaining amount is switched to be used for discharge. Therefore, use of the liquid storage portion that was used earlier for discharge can be suspended based on the physical remaining amount having a small error from the actual remaining amount. The liquid storage portion to be used next can be easily selected based on the estimated remaining amount.

(J) In the method for controlling a liquid discharge device according to (D), the remaining amount acquisition unit may include a detection unit configured to physically detect liquid stored in at least one of the liquid storage portions, and a calculation unit configured to calculate, based on a consumption amount of liquid consumed by the liquid discharge head discharging liquid, an estimated remaining amount in the liquid storage portion that supplies liquid, and the method for controlling a liquid discharge device may further include: physically detecting, by the detection unit, liquid stored in at least one of the liquid storage portions to acquire a physical remaining amount in the liquid storage portion; acquiring, by the calculation unit, the estimated remaining amount in at least one of the liquid storage portions; and when the physical remaining amount in one of the liquid storage portions used for discharge falls below the threshold value and there are a plurality of the liquid storage portions each having the shortest time limit, using, for discharge, liquid stored in the liquid storage portion having the physical remaining amount equal to or greater than the threshold value and having the smallest estimated remaining amount among the plurality of liquid storage portions.

According to this method, when there are a plurality of liquid storage portions having the shortest time limit, the liquid storage portion having a small estimated remaining amount is preferentially used. Therefore, the liquid storage portion to be used next can be easily selected based on the estimated remaining amount.

(K) A liquid discharge device includes: a liquid discharge head configured to discharge liquid; a mounting portion configured to allow three or more liquid storage portions storing the same type of liquid to be mounted thereon; a remaining amount acquisition unit configured to acquire a remaining amount of liquid stored in each of the liquid storage portions; and a control unit, in which the control unit performs control so as to, when a remaining amount in one of the liquid storage portions used for discharge falls below a threshold value, use, for discharge, liquid stored in the liquid storage portion having a smallest remaining amount among the liquid storage portions each having the remaining amount equal to or greater than the threshold value. According to this configuration, it is possible to achieve a similar effect as that of the method for controlling a liquid discharge device.

(L) A liquid discharge device includes: a liquid discharge head configured to discharge liquid; a mounting portion configured to allow three or more liquid storage portions storing the same type of liquid to be mounted thereon; and a remaining amount acquisition unit configured to acquire a remaining amount of liquid stored in each of the liquid storage portions; and a control unit, in which each of the liquid storage portions includes a storage element configured to store information related to liquid to be stored, the mounting portion includes at least one coupling portion that is electrically coupled to each of the storage elements, and the control unit performs control so as to acquire, based on the information obtained via the coupling portion coupled to the storage element, a time limit for use of the liquid stored in each of the liquid storage portions, and when a remaining amount in one of the liquid storage portions used for discharge falls below a threshold value, use, for discharge, liquid stored in the liquid storage portion having a closest time limit for use among the liquid storage portions each having a remaining amount equal to or greater than the threshold value. According to this configuration, it is possible to achieve a similar effect as that of the method for controlling a liquid discharge device.

What is claimed is:

1. A method for controlling a liquid discharge device including a liquid discharge head configured to discharge liquid, a mounting portion configured to allow three or more liquid storage portions storing a same type of liquid to be mounted thereon, and a remaining amount acquisition unit configured to acquire a remaining amount of liquid stored in each of the liquid storage portions,
the method for controlling a liquid discharge device comprising:
using, for discharge, liquid stored in one of the three or more liquid storage portions mounted on the mounting portion; and
when a remaining amount in one of the liquid storage portions used for discharge falls below a threshold value, using, for discharge, liquid stored in the liquid storage portion having a minimum remaining amount, which is a smallest remaining amount among the liquid storage portions each having a remaining amount equal to or greater than the threshold value.

2. The method for controlling a liquid discharge device according to claim 1, wherein
each of the liquid storage portions includes a storage element configured to store information related to liquid to be stored, and
the mounting portion includes at least one coupling portion that is electrically coupled to each of the storage elements, and
the method for controlling a liquid discharge device further comprises:
acquiring, based on the information obtained via the coupling portion coupled to the storage element, a time limit for use of the liquid stored in each of the liquid storage portions; and
when a remaining amount in one of the liquid storage portions used for the discharge falls below the threshold value and there are a plurality of the liquid storage portions each having the minimum remaining amount, using, for discharge, liquid stored in the liquid storage portion having a closest time limit for use among the plurality of liquid storage portions.

3. A method for controlling a liquid discharge device including a liquid discharge head configured to discharge liquid, a mounting portion configured to allow three or more liquid storage portions storing a same type of liquid to be mounted thereon, and a remaining amount acquisition unit configured to acquire a remaining amount of liquid stored in each of the liquid storage portions, in which each of the liquid storage portions includes a storage element configured to store information related to liquid to be stored, and the mounting portion includes at least one coupling portion that is electrically coupled to each of the storage elements,
the method for controlling a liquid discharge device comprising:
acquiring, based on the information obtained via the coupling portion coupled to the storage element, a time limit for use of the liquid stored in each of the liquid storage portions;
using, for discharge, liquid stored in one of the three or more liquid storage portions mounted on the mounting portion; and
when a remaining amount in one of the liquid storage portions used for discharge falls below a threshold value, using, for discharge, liquid stored in the liquid storage portion having a shortest time limit closest to the time limit for use among the liquid storage portions each having a remaining amount equal to or greater than the threshold value.

4. The method for controlling a liquid discharge device according to claim 3, further comprising:
when a remaining amount in one of the liquid storage portions used for discharge falls below the threshold value and there are a plurality of the liquid storage portions each having the shortest time limit, using, for discharge, liquid stored in the liquid storage portion having a remaining amount equal to or greater than the threshold value and having a smallest remaining amount among the liquid storage portions each having the shortest time limit.

5. The method for controlling a liquid discharge device according to claim 1, further comprising:
notifying an outside that a remaining amount in one of the liquid storage portions used for discharge falls below the threshold value.

6. The method for controlling a liquid discharge device according to claim 1, further comprising:
enabling replacement of the liquid storage portion when a remaining amount in one of the liquid storage portions used for discharge falls below the threshold value during discharge of liquid by the liquid discharge head.

7. The method for controlling a liquid discharge device according to claim 1, wherein
the remaining amount acquisition unit includes a detection unit configured to physically detect liquid stored in at least one of the liquid storage portions, and
the method for controlling a liquid discharge device further comprises:
physically detecting, by the detection unit, liquid stored in at least one of the liquid storage portions to acquire a physical remaining amount in the liquid storage portion.

8. The method for controlling a liquid discharge device according to claim 1, wherein
the remaining amount acquisition unit includes a calculation unit configured to calculate, based on consumption amount of liquid consumed by the liquid discharge head discharging liquid, an estimated remaining amount in the liquid storage portion that supplies liquid, and
the method for controlling a liquid discharge device further comprises:
acquiring, by the calculation unit, the estimated remaining amount in at least one of the liquid storage portions.

9. The method for controlling a liquid discharge device according to claim 3, further comprising:
notifying an outside that a remaining amount in one of the liquid storage portions used for discharge falls below the threshold value.

10. The method for controlling a liquid discharge device according to claim 3, further comprising:
enabling replacement of the liquid storage portion when a remaining amount in one of the liquid storage portions used for discharge falls below the threshold value during discharge of liquid by the liquid discharge head.

11. The method for controlling a liquid discharge device according to claim 3, wherein
the remaining amount acquisition unit includes a detection unit configured to physically detect liquid stored in at least one of the liquid storage portions, and the method for controlling a liquid discharge device further comprises:
physically detecting, by the detection unit, liquid stored in at least one of the liquid storage portions to acquire a physical remaining amount in the liquid storage portion.

12. The method for controlling a liquid discharge device according to claim 3, wherein
the remaining amount acquisition unit includes a calculation unit configured to calculate, based on a consumption amount of liquid consumed by the liquid discharge head discharging liquid, an estimated remaining amount in the liquid storage portion that supplies liquid,
the method for controlling a liquid discharge device further comprises:
acquiring, by the calculation unit, the estimated remaining amount in at least one of the liquid storage portions.

13. The method for controlling a liquid discharge device according to claim 1, wherein
the remaining amount acquisition unit includes
a detection unit configured to physically detect liquid stored in at least one of the liquid storage portions, and
a calculation unit configured to calculate, based on a consumption amount of liquid consumed by the liquid discharge head discharging liquid, an estimated remaining amount in the liquid storage portion that supplies liquid, and
the method for controlling a liquid discharge device further comprises:
physically detecting, by the detection unit, liquid stored in at least one of the liquid storage portions to acquire a physical remaining amount in the liquid storage portion;
acquiring, by the calculation unit, the estimated remaining amount in at least one of the liquid storage portions; and
when the physical remaining amount in one of the liquid storage portions used for discharge falls below the threshold value, using, for discharge, liquid stored in the liquid storage portion having a smallest estimated remaining amount among the liquid storage portions each having the physical remaining amount equal to or greater than the threshold value.

14. The method for controlling a liquid discharge device according to claim 4, wherein
the remaining amount acquisition unit includes
a detection unit configured to physically detect liquid stored in at least one of the liquid storage portions, and
a calculation unit configured to calculate, based on a consumption amount of liquid consumed by the liquid discharge head discharging liquid, an estimated remaining amount in the liquid storage portion that supplies liquid, and
the method for controlling a liquid discharge device further comprises:
physically detecting, by the detection unit, liquid stored in at least one of the liquid storage portions to acquire a physical remaining amount in the liquid storage portion;
acquiring, by the calculation unit, the estimated remaining amount in at least one of the liquid storage portions; and
when the physical remaining amount in one of the liquid storage portions used for discharge falls below the threshold value and there are a plurality of the liquid storage portions each having the shortest time limit, using, for discharge, liquid stored in the liquid storage portion having the physical remaining amount equal to or greater than the threshold value and having the smallest estimated remaining amount among the plurality of liquid storage portions.

15. A liquid discharge device comprising:
a liquid discharge head configured to discharge liquid;
a mounting portion configured to allow three or more liquid storage portions storing a same type of liquid to be mounted thereon;
a remaining amount acquisition unit configured to acquire a remaining amount of liquid stored in each of the liquid storage portions; and
a control unit, wherein
the control unit performs control so as to
when a remaining amount in one of the liquid storage portions used for discharge falls below a threshold value, use, for discharge, liquid stored in the liquid storage portion having a smallest remaining amount among the liquid storage portions each having the remaining amount equal to or greater than the threshold value.

16. A liquid discharge device comprising:
a liquid discharge head configured to discharge liquid;
a mounting portion configured to allow three or more liquid storage portions storing a same type of liquid to be mounted thereon; and
a remaining amount acquisition unit configured to acquire a remaining amount of liquid stored in each of the liquid storage portions; and
a control unit, wherein
each of the liquid storage portions includes a storage element configured to store information related to liquid to be stored,
the mounting portion includes at least one coupling portion that is electrically coupled to each of the storage elements, and
the control unit performs control so as to
acquire, based on the information obtained via the coupling portion coupled to the storage element, a time limit for use of the liquid stored in each of the liquid storage portions, and
when a remaining amount in one of the liquid storage portions used for discharge falls below a threshold value, use, for discharge, liquid stored in the liquid storage portion having a closest time limit for use among the liquid storage portions each having a remaining amount equal to or greater than the threshold value.
